(19) United States
(12) Patent Application Publication
(10) Pub. No.: US 2026/0318718 A1
(43) Pub. Date: Oct. 15, 2026

(54) LOW FORCE SENSOR

(71) Applicant: Waterloo Instruments Inc., Waterloo (CA)

(72) Inventors: Caleb HORST, Waterloo (CA); Jamie HOLMAN, Waterloo (CA); Jim VELDHUIS, Waterloo (CA)

(21) Appl. No.: 19/174,206

(22) Filed: Apr. 9, 2025

(51) Int. Cl. G01D 5/28; G01L 5/00

(52) U.S. Cl. CPC G01D 5/28; G01L 5/00

(57) ABSTRACT

The disclosure is directed at a low force sensor for measuring loads that are applied at an end of a flexible member. The flexible member is mounted at one end to a housing and flexes in response to a load applied at an opposite end of the flexible member. The low force sensor includes an optical sensor and a light source whereby deflection of the flexible member causes the light source to move over the optical sensor which captures the movement of the light via images. The images are then processed to determine the force applied to the low force sensor.

### FIELD

The disclosure is generally directed at the field of testing in research and development environments, and more specifically, at a low force sensor.

### BACKGROUND

In some research and development environments, such as in material science or the medical testing field; there is a need to detect subtle pressure changes during the research process. Certain components may be very sensitive to small force variations.

Many current force sensors use a strain gauge bonded to a flexible member whose electrical resistance changes with deflection. In these solutions, the force sensor is generally designed such that the change in electrical resistance (which may be seen as a resistance measurement) varies linearly with applied load such that the force applied may be determined or calculated based on the measured change in electrical resistance.

In low force sensors that employ a bonded strain gauge, one problem is that these types of sensors are unable to handle higher applied loads without the sensors being damaged.

Strain gauges have a relatively small resistance change before they fail. If a sensor is designed such that it the strain gauge has only a small amount of strain at the rated load, the sensor would have a low signal-to-noise ratio. It is therefore desirable to design the sensor such that at their rated load, the strain gauges use a large portion of the pre-failure strain, however, these types of sensors may be damaged by loads greater than the rated load which exceed the strain limit of the strain gauge. In some cases, the deflection of the deformation of the flexible member is limited by a mechanical stop. In practice, the implementation of a mechanical stop is difficult because the deflections are very small for low force sensors.

In low force sensors that employ non-contacting methods to measure the deflection of the flexible load-sensing member, it is common to employ a long, thin member and apply the load to the target at the end of this member. The end position of the member is measured optically, magnetically, electrically, acoustically, or by some other non-contact means. The challenges with this approach are developing a remote displacement detection method that does not interfere with the operation of the equipment and/or ensuring that the flexible member mounted securely, oriented correctly, and is precisely the desired length and cross section dimensions.

Therefore, there is provided a low force sensor that overcomes disadvantages of current solutions.

### SUMMARY

In one aspect of the disclosure, there is provided a low force sensor including a housing; a flexible member mounted at one end to the housing and including a second end extending out of the housing, the flexible member including a block portion; a light source connected to the block portion, the light source directing light through the block portion; and an optical sensor for capturing a light beam exiting the block portion.

In another aspect, the block portion includes a light collection area at one end and a hole at the other end whereby the light collection area focusses received light beams at the hole. In yet another aspect, the second end of the flexible member includes an attachment portion to receive end effectors. In a further aspect, flexible member includes a first portion mounted at one end of the housing; and a second portion, connected in a non-parallel manner, to the first portion. In yet another aspect, the second portion is perpendicular to the first portion.

In an aspect, the sensor further includes a processor for processing images captured by the optical sensor. In another aspect the processor calculates a force applied to the low force sensor. In a further aspect, the block portion is a pinhole camera. In another aspect, the end effectors includes at least one of compression plates, tension grips, components for bending a test material, components for shearing a test material or components for producing an indentation on a test material.

### BRIEF DESCRIPTION OF THE DRAWINGS

Further features and exemplary advantages will become apparent from the following detailed description, taken in conjunction with the appended drawings, in which:

FIGS. 1a to 1e are schematic diagrams of a first embodiment of a low force sensor;

FIG. 2 is a schematic side view of a block portion;

FIGS. 3a to 3c are schematic diagrams of a second embodiment of a low force sensor;

FIG. 4 is a perspective view of one embodiment of a testing measurement setup with tension grips;

FIG. 5 is a flowchart showing a method of calibration; and

FIG. 6 is a flowchart showing a method of measuring a force applied using a low force sensor of the disclosure.

### DETAILED DESCRIPTION OF THE EMBODIMENTS

The disclosure is directed at a low force sensor. In one embodiment, the disclosure includes a flexible member that is mounted, attached or fastened to an inner wall of a housing at one end. The flexible member also includes an end that extends out of the housing to which force or a load may be applied. The disclosure further includes a light source that directs a light beam through a predetermined section of the flexible member whereby displacement or deflection of the flexible member (and therefore the light beam) in response to the force being applied to the flexible member is captured by an optical sensor. A measurement of the force applied is then calculated or determined based on the displacement of the light beam and a calibration factor. In some embodiments, the low force sensor of the disclosure is for use with low loads such as below about 10 newtons. In yet other embodiments, the low force sensor of the disclosure is for use with loads applying a force lower than about 1 newton.

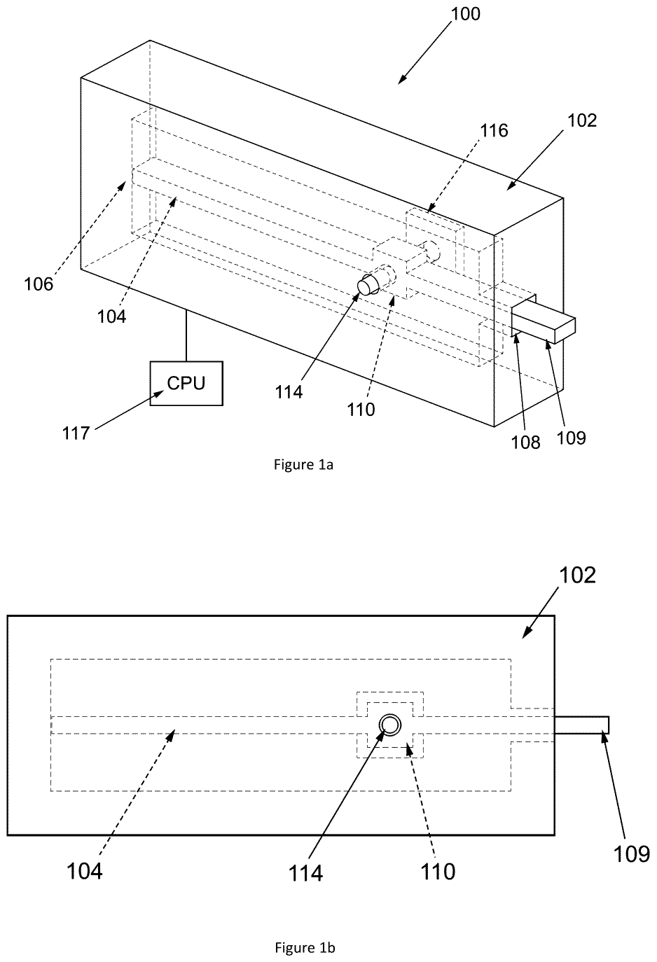

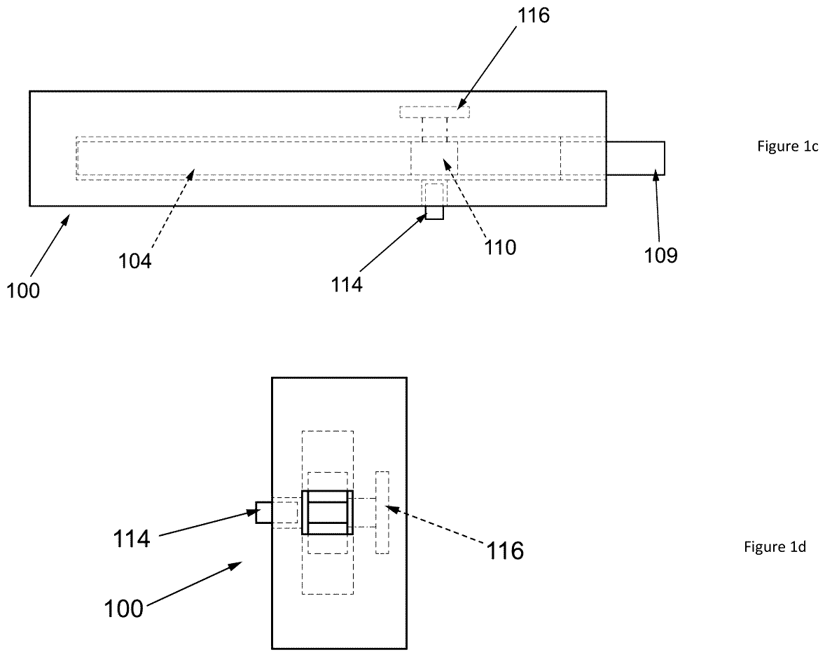

Turning to FIG. 1a, a perspective view of a first embodiment of a low force sensor is shown. FIG. 1b is a front view of the low force sensor, FIG. 1c is a top view of the low force sensor and FIG. 1d is a side view of the low force sensor. In FIGS. 1a to 1d, the internal components of the sensor are shown in dotted lines. FIG. 1e is a perspective view of the low force sensor with the housing in dotted lines and some of the internal components in solid line.

The sensor 100 includes a housing 102 and a flexible member 104. In the current embodiment, the flexible member 104 is mounted, attached or fastened at one end to an inner wall 106 of the housing 102 while an opposite end of the flexible member 104 extends out of the housing 102 through an opening 108. The opposite end of the flexible member 104 may be seen as an extended end 109.

The flexible member 104 includes a block portion 110 that is positioned at a fixed distance along a length of the flexible member 104. In some embodiments, the block portion may sit within a pocket that controls the distance that the block portion travels. In other embodiments, the housing may include physical stops of barriers to control the distance of travel of the block portion. In some embodiments, the positioning of the block portion 110 is a predetermined distance away from the extended end 109 of the flexible member 104 or where the application of force is applied. This enables the mounting of grips, plates, or other end effectors to the extended end 109 that may be required for low force testing or sensing. In some embodiments, other end effectors may include, but are not limited to, components for providing as indentation in a test material, components for bending a test material or components for shearing a test material. It is appreciated that the end effectors added or mounted to the extended end 109 do not affect the calculation or determination of the load or force that is applied to the low force sensor 100 as in use or operation, the force that is being measured by the low force sensor 100 is applied to the extended end 109.

In some embodiments, the section of the flexible member 104 between the extended end 109 and a block portion 110 is stiffer than the section of the flexible member 104 between the block portion 110 and the mounting location of the flexible member 104 to the inner wall 106 to enable higher overload protection and easier end effector mounting.

The characteristics of the flexible member 104 are closely related to the range of force that the low force sensor is capable of measuring. Based on the cantilever beam bending equation for a rectangular beam (or the portion of the flexible member between the block portion and the mounted end), a thickness of this portion of the member can be changed so the flexible member deflects approximately 200-250 um under its maximum load, which corresponds to 80-100 pixels. The thinner the beam the more it bends under smaller forces. In specific embodiments, a flexible member with a thickness of about 0.55 mm may be able to handle a load of up to about 2 g while a flexible member with a thickness of about 2.3 mm may be able to handle a load up to about 200 g.

The sensor 100 further includes a light source 114 that is mounted, or connected, to the block portion 110 on one side of the flexible member 104. An optical sensor 116 is mounted to an inside wall of the housing 102 on an opposite side of the flexible member 104 from the light source 114. The low force sensor 100 may also include a processor or central processing unit (CPU) 117 for processing images captured by the optical sensor 116 and/or for calculating or determining the force that has been applied to the low force sensor 100. In some embodiments, the CPU 117 may be part of the low force sensor 100 and, in other embodiments, the CPU 117 may not be part of the sensor but may still be used to process the images and/or calculate the force applied. In some embodiments, multiple CPUs may be used where one CPU processes the images and another CPU calculates the force applied as will be discussed below. In yet other embodiments, the low force sensor may include a communication component that enables the low force sensor to communicate with a remote CPU.

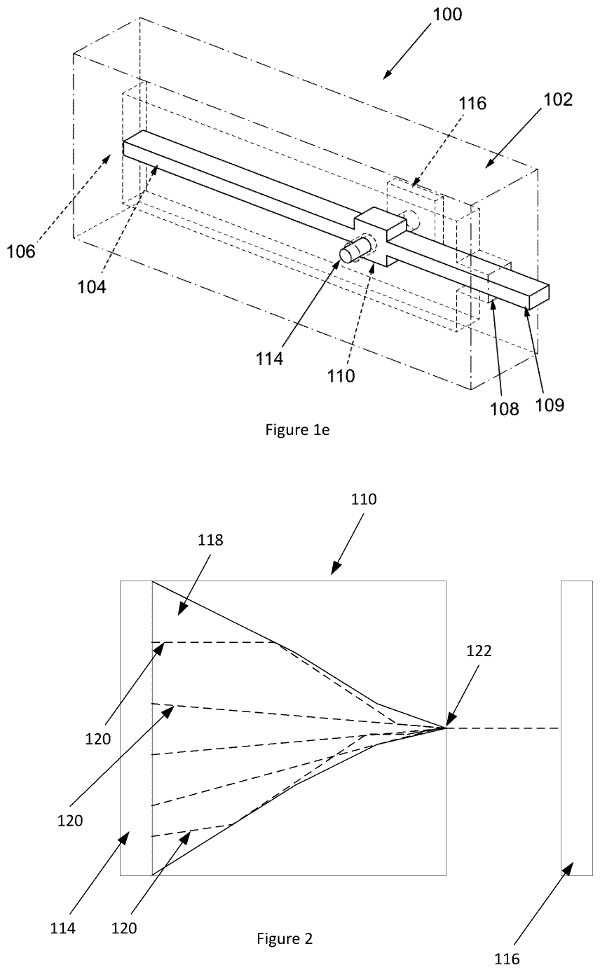

As shown in more detail in FIG. 2, which is a cut-away view of the block portion, the block portion 110 includes an opening 118 (which may be seen as a light receiving area) which receives light beams 120 that are emitted or transmitted by the light source 114. In the current embodiment, the light source 114 is mounted to an open end of the block portion 110. In other embodiments, the light source 114 may be smaller than the end of the block portion 110 whereby the light source is embedded in a wall of the block portion 110.

At an opposite end of the block portion 110 (closer to the optical sensor 116), the block portion includes a hole 122, such as, but not limited to a pinhole. As can be seen in FIG. 2, an interior of the block portion 110 is designed to direct the light beams 120 towards the hole 122 in a similar manner to how a pinhole camera operates. The pinhole 120 then directs a pinhole sized light beam toward the optical sensor 116, which in some embodiments may be a Complementary Metal-Oxide Semiconductor (CMOS) sensor or a charge-coupled device (CCD). The optical sensor 116 captures images of the light beam when it is activated. As discussed above, the design of the block portion 110 enables a more focussed light beam to exit the block portion 110.

As will be described below, the focussed light beam provides a more distinct image to be obtained. Furthermore, as described above, movement of the block portion 110 is controlled such that the light beam does not travel past the optical sensor such that the light beam always remains within the area of the optical sensor so that an image with a light beam present can be continuously captured when a force is being applied to the low force sensor.

Movement of the light is in a single direction or single axis or single place, which in some embodiments may be in a vertical direction to facilitate the calculation of the applied force. By only having the light beam travel in a single axis or plane, a calculation of the displacement of the light beam as force is applied is a more simple calculation.

In a rest state (when no force is being applied to the low force sensor 102), the light beam travels through the hole 122 (that is aligned with the optical sensor 116) and is captured by the optical sensor 116 in the form of an image. By focussing the light beam exiting the block portion 110, a position of a centroid of this light beam can be captured via the image. The area, or location, where the directed, or focussed, focussed beam of light hits the optical sensor 116 may be referred to or represent a starting, or at rest, position for the low force sensor 100. As understood, in some embodiments, the light beam that contacts the camera component is circular in nature with a centroid. In other embodiments, light beams having other shapes may be used with a centre point of the light beam representing the centroid of circular light beam. In some embodiments, the light beam that is provided by the light source 114 may be designed to have an engineered or predetermined shape.

In some embodiments, positioning of the block portion 110 or hole 122 is in a location where the optical sensor 116 can be factory calibrated to correlate deflections experienced by the flexible member 104 when a load is applied to the low force sensor. In alternative embodiments, the block portion 110 may include an optical shield with a hole 122 to facilitate optical tracking of the transmitted or focussed light beam. The combination of the light source 114, the hole 112 and the optical sensor 116 provide accurate, non-contact position tracking or displacement measurements at a known position on the flexible member without interfering with the engineered functional geometry at the point of load application or where the force is applied to the flexible member.

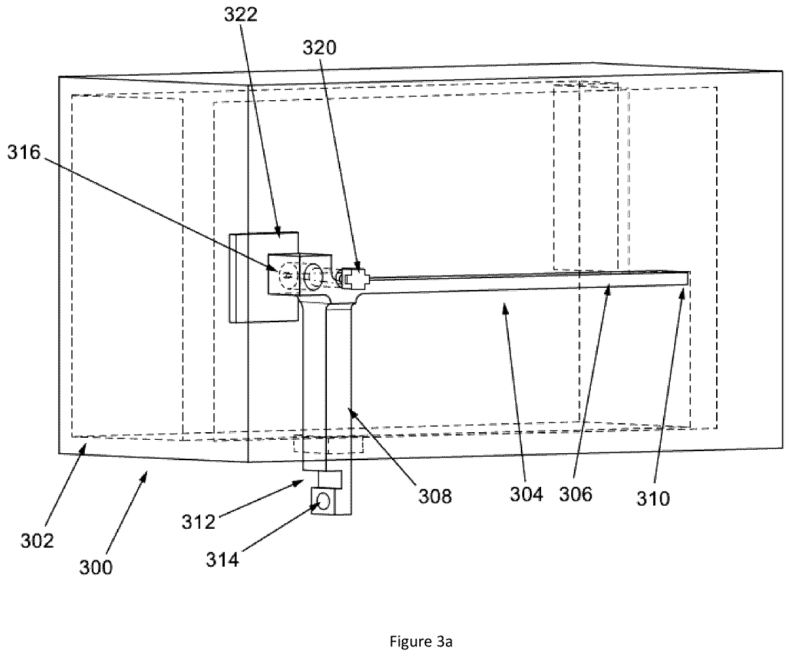

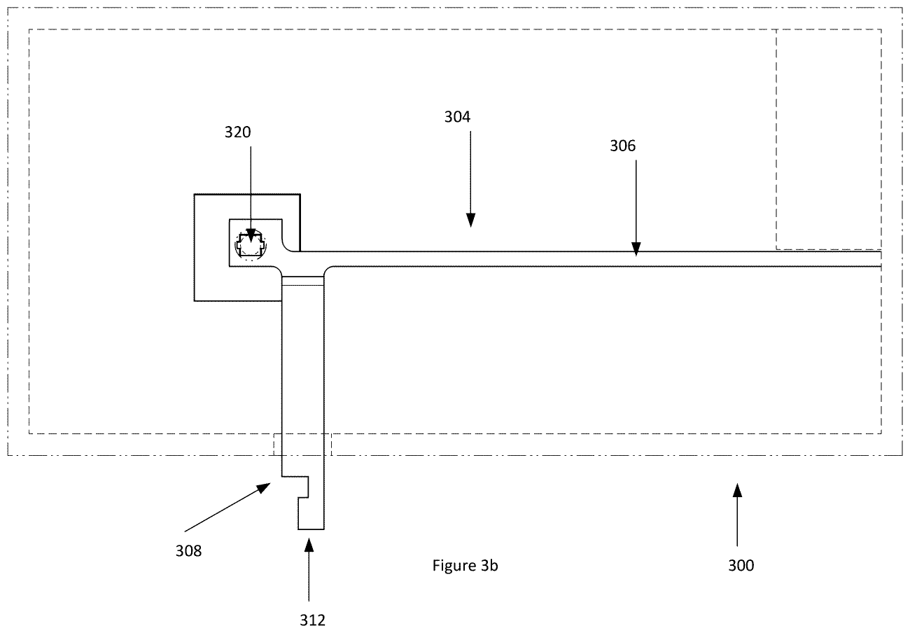

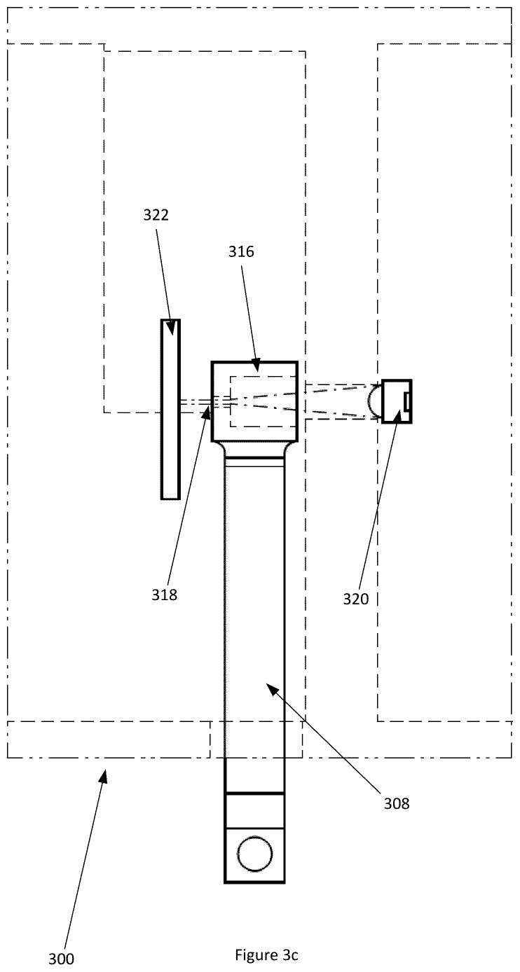

Turning to FIGS. 3a to 3c, schematic diagrams of another embodiment of a low force sensor are shown. FIG. 3a is a perspective view, FIG. 3b is a front view, and FIG. 3c is a side view of the low force sensor.

In the current embodiment, the low force sensor 300 includes a housing 302 and a flexible member 304 that includes a first portion 306 and a second portion 308, where the second portion 308 is perpendicular to the first portion 306. One end 310 of the first portion 306 is mounted to the housing 302 while one end 312 of the of the second portion 308 extends out of a housing 302. As discussed above, characteristics of the first portion 306 are selected such that a maximum load capacity that can be handled by the low force sensor 300 may be controlled. Beam thicknesses (of the first portion 306) for handling low force sensors to handle load forces up to 0.02N, 0.05N, 0.2N, 0.5N, 1N and 2N are contemplated, however, it is understood that beams of other thicknesses may also be contemplated. It is understood that there are no restrictions with respect to the characteristics of the second portion 308 except for an understanding that the second portion 308 should not deflect under its own weight when the system is at rest. In some embodiments, design of the second portion 308 may be performed in relation to the characteristics of the first portion 306 so that a weight of the second portion 308 has no effect when the system is at rest.

The one end 312 of the second portion 308 includes a hole or connector portion 314 enabling other components, such as, but not limited to, tension grips or compression plates, to be attached to the flexible member 304. The flexible member 304 further includes a block portion 316 that is similar, or identical, to the block portion 110 of the embodiment of FIG. 1.

The sensor 300 further includes a light source 320 that is associated with the block portion 316 and directs light through a hole 318 (as schematically shown in FIG. 3c) towards an optical sensor, or camera component 322 that is mounted to the housing 302. The camera component 322 is mounted on a side of the flexible member 304 that is opposite the light source 320.

In use, as force is applied to the portion of the flexible member 104 or 304 that extends out of its respective housing, the flexible member moves in response to the applied force causing the block portion to move in an up and down position (perpendicular to an axis of flexible member 104 or parallel to an axis of the second portion 308 of flexible member 304). Due to the connection between the light source and the block portion, the focussed light beam emitting from the block portion also moves up and down (whereby the movement is captured by the camera component or optical sensor) which continuously captures images of the moving light beam. In one embodiment, as the centroid (or centre) of the light beam moves up and down on the optical sensor, continuous images are obtained or captured and then transmitted to the CPU for processing. Processing of the images may result in a distance determination, such as the difference in position of the centre of the light beams, between any two images that are captured. The distance determination is then multiplied by a calibration factor (as discussed below) to obtain a force measurement. In one embodiment, the calibration factor is measured in mN/pixel.

While a block portion that moves in only one direction is a most basic version, in other embodiments, the block portion may move in multiple directions that is addressed in the calibration phase.

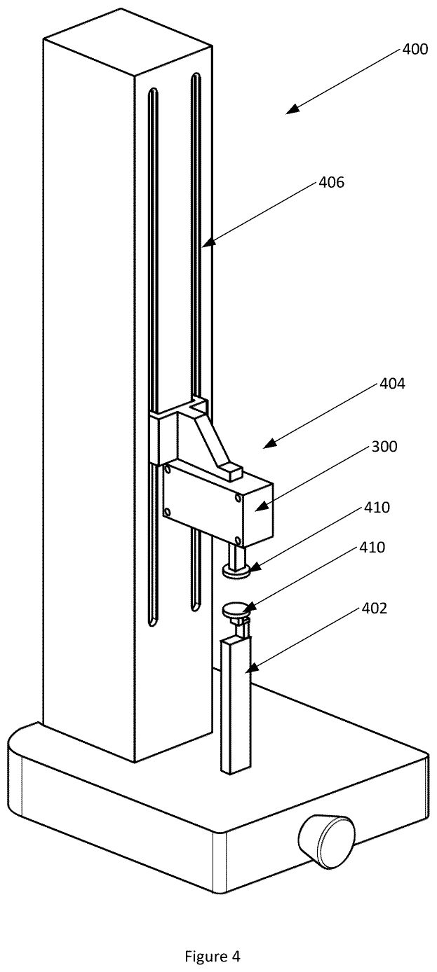

As shown in FIG. 4, a schematic diagram of the low force sensor 300 installed within a force measurement system is shown. In the current embodiment, the low force measurement system 400 (which may be seen as a material testing machine) includes a static bottom testing portion 402 and a moveable upper testing portion 404. Examples of a material include, but is not limited to, a biomaterial. The low force sensor 304 is part of the moveable upper testing portion 404.

The testing machine 402 includes a pair of rails 406 to which the upper testing portion 404 is connected to or mounted to allowing the upper testing portion 404 (or the low force sensor) to move up and down the testing machine 400. In the current embodiment, a pair of compression plates 408 are connected to the bottom testing portion 402 and the low force sensor 304 of the upper testing portion 404.

During testing of a material, an object of interest may be placed on the compression plate 410 that is connected to the bottom testing portion 402. The upper testing portion 404 is then moved such that it travels up and down the rails in a predetermined manner. As the upper testing portion 404 is moving toward the bottom testing portion 404 (and in contact with the object of interest and the stationary or static bottom testing portion 402), the flexible member 304 flexes or deflects as the upper testing portion 402 moves closer to the bottom testing portion 402 but both compression plates 410 continue to hold the object of interest, such as a biomaterial, in place.

As the upper testing portion 404 moves, the flexible member flexes and the light beam travels in an up and down motion that is captured by the optical sensor. Images of the movement of the centroid or centre of the light beam are then transmitted for processing to determine the force that is being applied to the material being tested. In some embodiments, the testing may be to test the stress and/or strain of the material whereby the system 400 may determine when the material breaks and then calculate the force that was applied at that moment in time by multiplying the difference in distance between the centroid or centre of the light beam at rest and the centroid or centre of the light beam when the material broke or snapped with the calibration factor.

In other embodiments, tension grips may be used in place of the compression plates where the upper testing portion 404 is moved away from the bottom testing portion 402. As discussed above, other end effectors are contemplated.

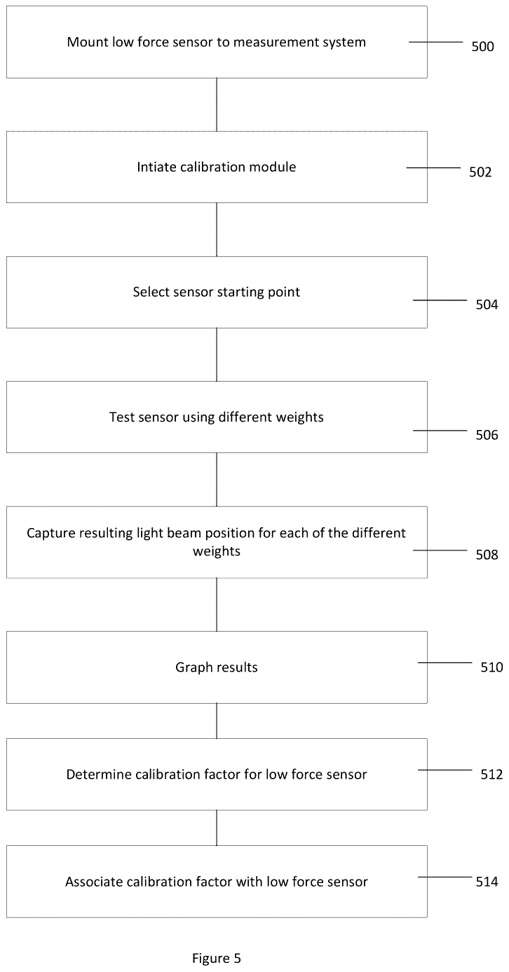

Turning to FIG. 5, a flowchart showing a method of calibrating a low force sensor is shown. The calibration of the low force sensor determines the calibration factor for the specific low force sensor. As understood, each low force sensor needs to be calibrated as their calibration factor may be different than other similarly produced low force sensors.

Initially, the low force sensor is mounted to a system (500). After it has been mounted, the CPU is started in order to initiate a calibration module (502). In some embodiments, the CPU and the low force sensor are in communication with each other such that when one of the CPU or low force sensor is turned on, the other of the low force sensor or CPU is turned on.

The low force sensor is then manipulated (without any fixtures or weights) to designate or select a sensor starting point (504). In one embodiment, the flexible member may be moved or manipulated so that the light beam is directed at and sensed by the optical sensor whereby a centroid or centre of the focussed light beam represents the sensor starting point or centre point.

Different weights may then be mounted or hung on the low force sensor (506) and the resulting location of the centre of the light beam for each of the different weights is captured by the optical sensor (508). In one embodiment, the system may determine a number of pixels away from the sensor starting point that the light has been deflected with respect to each of the different weights. In one embodiment, nine (9) weights that span a full scale of the low force sensor may be used to generate an average of pixels deflected for each weight. In some embodiments a linear curve fit may be used to determine the calibration factor.

The results are then plotted on a graph (510) based on the measured deflection in pixels vs the force applied (as known by the weights). The calibration factor for the low force sensor is then determined or calculated (512). In one embodiment, the calibration factor is determined by a slope of the graph (in mN/pixels). The calibration factor is then associated with or programmed to the specific low force sensor (514). In some embodiments, the calibration factor may be stored in a database along with information identifying the associated low force sensor. In other embodiments, the calibration factor is stored in the CPU whereby when the low force sensor is to be used, the CPU retrieves the calibration factor from memory.

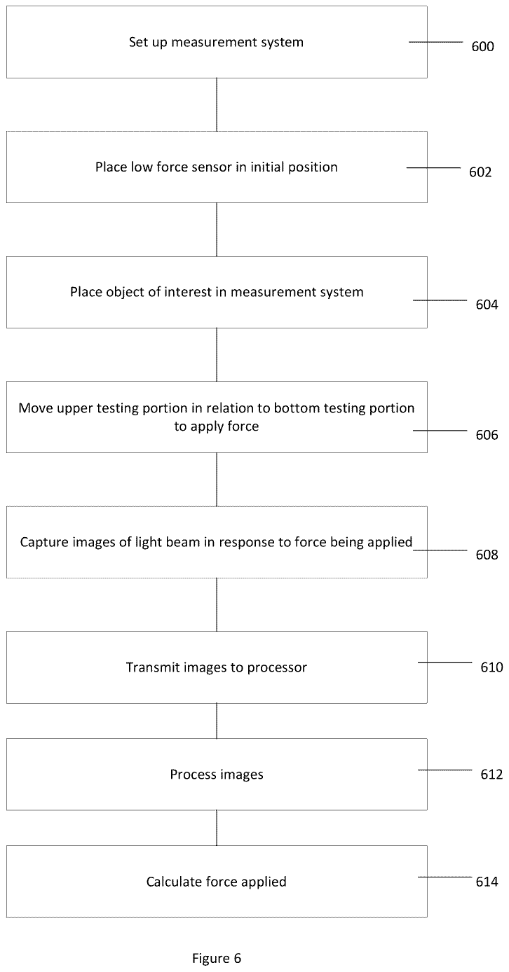

Turning to FIG. 6, a flowchart showing a method of determining force using a low force sensor is shown.

Initially, the force measurement is set up (600). Examples of a compression plate force measurement setup is shown in FIG. 4. It is understood that the method of the disclosure may include some or all of the individual components of the flowchart of FIG. 6.

The low force sensor is the placed in an initial testing, or rest, position (602) whereby the light beam is directed at the sensor starting point. In one embodiment, the upper testing portion is placed a predetermined distance away from the bottom testing portion and the low force sensor (as part of the upper testing portion) is at rest.

An object of interest, such as, but not limited to a test material or item, is then placed into the measurement system (604). In some embodiments, a test material is placed atop the bottom compression plate. The testing machine then applies a force to the testing material (606). In one embodiment, the testing machine may apply a force to the low force sensor component to move it towards the stationary plate portion. In other embodiments, the testing machine may move the upper testing portion away from the bottom testing portion such as when tension grips are being used.

With the low force sensor, as the force is being applied, the flexible member moves or deflects in response to the force applied causing the block portion to move up and down within the housing. As the flexible member deflects, the centroid or centre of the light beam moves in a similar or parallel manner. The movement of the centroid or centre of the light beam with respect is captured by the optical sensor (608) in the form of digital images. As discussed above, movement of the light beam is in a single plane (i.e. a vertical plane). The images captured by the camera are then transmitted to a processor or central processing unit (610). The processor then processes the images (612). In one embodiment, the images are processed to determine a location of the centroid or centre of the light beam within the processed image and then determines the distance between the centre of the light beam in the processed image and the centre of the light beam at the starting or rest position. This may be calculated in terms of pixels. As the light beam is controlled to only travel in a single plane, the calculation of the distance the light beam has displaced in response to the deflection of the flexible member is more easily calculated. In other embodiments, the system may compare the received images with a calibration image (representing the sensor starting point) to determine the number of pixels the centroid or centre of the light beam has moved with respect to the sensor starting point. The processor then calculates the force applied (614). In one embodiment, the processor multiplies distance (in pixels) by the calibration factor (such as determined by the method of FIG. 5) to determine the amount of force applied.

In some embodiments, the optical sensor continuously obtains images as the centroid or centre of the light beam is moving and continually transmits these images to the CPU such that a continuous number of force measurements are obtained. Depending on the type of testing that is being performed, the user may be interested in when the test material breaks under stress or strain (images that represent when the centroid or centre of the light beam is farthest from the sensor starting point) or may be interested in other characteristics of the test material whereby images that represent when the centroid or centre of the light beam is between the sensor starting point and a highest deflection or distance point may be of interest.

In other embodiments, the measurement system may operate where a force output is constantly measured. In this example, the measurements may be performed at a specific frequency where force is captured over a time range.

In some embodiments, the flexible member may be multiple separate pieces. In other embodiments, the distances between each of the fixed end, the light source and the optical sensor are all fixed relative to each other.

Advantages of the current disclosure include, but are not limited to, the block portion of the flexible member is placed at a fixed location to facilitate deflection, the flexible member is geometrically complex to facilitate higher overload protection and easier fixture mounting; and there is less need to control light characteristics such as light intensity since the low force sensor of the disclosure relies on light beam position to determine the force applied. In other words, the shape of the light beam may be designed or selected to not overbend.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding.

Single axis or position of light parallel to the force applied

What is claimed is:

1. A low force sensor comprising:
a housing;
a flexible member mounted at one end to the housing and including a second end extending out of the housing, the flexible member including a block portion;
a light source connected to the block portion, the light source directing light through the block portion; and
an optical sensor for capturing a light beam exiting the block portion.

2. The low force sensor of claim 1 wherein the block portion comprises:
a light collection area at one end and a hole at the other end whereby the light collection area focusses received light beams at the hole.

3. The low force sensor of claim 1 wherein the second end of the flexible member comprises an attachment portion to receive end effectors.

4. The low force sensor of claim 1 wherein the flexible member comprises:
a first portion mounted at one end of the housing; and
a second portion, connected in a non-parallel manner, to the first portion.

5. The low force sensor of claim 4 wherein the second portion is perpendicular to the first portion.

6. The low force sensor of claim 1 further comprising a processor for processing images captured by the optical sensor.

7. The low force sensor of claim 6 wherein the processor further calculates a force applied to the low force sensor.

8. The low force sensor of claim 1 wherein the block portion is a pinhole camera.

9. The low force sensor of claim 3 wherein the end effectors comprise at least one of compression plates, tension grips, components for bending a test material, components for shearing a test material or components for producing an indentation on a test material.
